(19) United States
(12) Patent Application Publication
(10) Pub. No.: US 2009/0125962 A1
(43) Pub. Date: May 14, 2009

(54) AUTOMATIC DIGITAL CONTENT MIGRATION SYSTEM FOR THEATERS

(76) Inventors: William James Colosky, JR., Honeoye Falls, NY (US); Rohan S. Khaleel, Rochester, NY (US)

Correspondence Address: Frank Pincelli;Patent Legal Staff, Eastman Kodak Company, 343 State Street, Rochester, NY, 14650-2201, US

(21) Appl. No.: 11/938,503

(22) Filed: Nov. 12, 2007

(51) Int. Cl. H04N 7/173

(52) U.S. Cl. 725/116

(57) ABSTRACT

A method for transmitting digital content for a movie theater, the method includes the steps of receiving a schedule of the digital content; determining transmission prioritization requirements for transmission of the digital content according to one or more of either content size, schedule showtime, or network characteristics; and transmitting the digital content to one or more digital content players based on the determined prioritization.

### FIELD OF THE INVENTION

The present invention relates generally to the field of digital cinema and more particularly to an automated method for prioritizing download of digital content to a plurality of digital content players.

### BACKGROUND OF THE INVENTION

Currently, digital cinema systems include a ticketing system that contains information about what movies are playing at the particular theater and the scheduled showtime of the movie. Tickets for a movie can be purchased either online, at a kiosk or at the ticketing window at the particular theater. These purchases are coordinated by the ticketing system. A theater management system then uses the ticketing system information to schedule the particular movie, which includes feature content and non-feature content (such as pre-show, trailers, advertising, and post-show content), in digital form, to a designated auditorium in the theater. Each auditorium includes a digital content player to which the non-feature and feature content for that particular auditorium is downloaded using a network. The non-feature and feature content is then presented to the audience according to the schedule.

In some instances, the network infrastructure becomes overloaded causing content to be delayed being delivered to the particular digital content player. It is happenstance as to which particular digital content player has its digital content being delayed. This is undesirable because in most instances one auditorium has a more immediate need for its content due to the scheduled showtime.

Although the presently known and utilized method and system is satisfactory, it includes the above-described drawbacks of causing undesirable delays in getting content to a digital content player that needs the content more urgently than others. The present invention overcomes this drawback.

### SUMMARY OF THE INVENTION

The present invention is directed to overcoming one or more of the problems set forth above. Briefly summarized, according to one aspect of the present invention, the invention resides in a method for transmitting digital content for a movie theater, the method comprising the steps of receiving a schedule of the digital content; determining transmission prioritization requirements for transmission of the digital content according to two or more of either content size, scheduled showtime, or network characteristics; and transmitting the digital content to one or more digital content players based on the determined prioritization.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the advantage of an automated method for efficiently moving digital content to the designated digital content player at the most efficient time.

### BRIEF DESCRIPTION OF THE DRAWINGS

FIG. 1 is a block diagram of the present invention;

FIG. 2 is a perspective view of hardware typically used in a theater management system;

FIG. 3 is flowchart illustrating logic for the migration engine;

FIG. 4 is a graph illustrating bandwidth at various times; and

FIG. 5 is diagram illustrating an overview of the present invention.

### DETAILED DESCRIPTION OF THE INVENTION

Before discussion the present invention, it is useful to define terms as used herein. In this regard, “pausing” means reducing the allocated bandwidth to zero. “Digital content” or “content” is defined as: (a) feature content(s) or non-feature content(s) (both in digital format); or (b) feature content(s) and non-feature content(s) (both in digital format) combined. Still further, as used herein, computer readable storage medium may comprise, for example; magnetic storage media such as a magnetic disk (such as a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

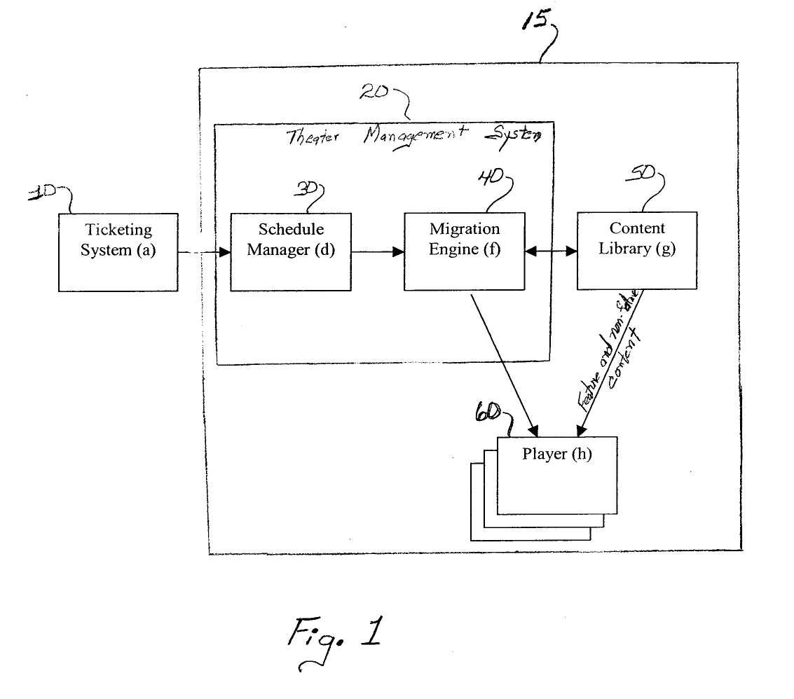

Referring to FIG. 1, there is shown a block diagram illustrating an overview of the present invention. A ticketing system 10 is used for purchasing tickets for entrance into movie theaters 15. The ticketing system 10 may include a point-of-sale purchase, such as a ticket window at the theater or from a ticketing kiosk, or purchases from online systems. The ticketing system 10 inputs scheduled showtimes for each movie into a theater management system 20.

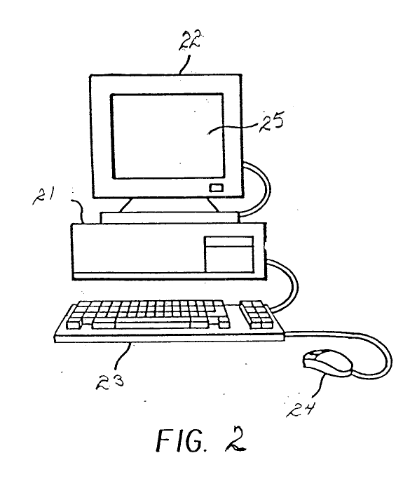

Referring briefly to FIG. 2, the theater management system 20 includes but is not limited to, from a hardware perspective, a microprocessor-based unit 21 for processing algorithms, software programs and firmware. A monitor 22 is used to display various information from the algorithm, software program or firmware and to display various input as input by a user. The input is input by either one or more of a keyboard 23, mouse 24 or touch-sensitive screen 25.

Referring back to FIG. 1, the theater management system 20, from a software or firmware perspective, includes a schedule manager 30 that takes the scheduled showtimes for each movie and schedules the particular show in a designated auditorium at a designated time. Both feature and non-feature content (such as advertising and the like as defined above) are scheduled. This is usually done manually by an operator who manipulates the schedule including changing the scheduled showtime received from the ticketing system. It is noted for clarity of understanding that the non-feature content and the feature content are in digital form.

A migration engine 40 receives the schedule and determines prioritization requirements for transmission of the digital content to the content players 60 according to one or more of either: content size, schedule showtime, network characteristics, number of current transmissions, or number of digital content players. In some cases, it may be preferable to use two or more of the listed factors in lieu of one. A content library 50 includes a database that stores the file size of the digital content that is sent to the migration engine 40 for inclusion in the prioritization. Feature and non-feature content is migrated to the content player 60 from the content library 50. In this regard, the migration engine 40 may instruct the content player 60 to retrieve content from the content library 50. Alternatively, the migration engine 40 may instruct the content library 50 to send content to the content player 60.

Turning now to the prioritization requirements, the scheduled showtime is a portion of the received schedule and network characteristics include, but are not limited to, the bandwidth of the network infrastructure including the wires, switches and the like. These network characteristics are known quantities, or derived quantities based on analyzing actual network behavior (learning from current and prior concurrent transmissions to two or more players an actual total bandwidth). The network characteristics are stored in storage in the theater management system 20. The number of digital content players 60 is also known as they are located in each auditorium, and this information is stored in the theater management system 20. The migration engine 40 determines current available transmission bandwidth for the particular network of digital content players 60.

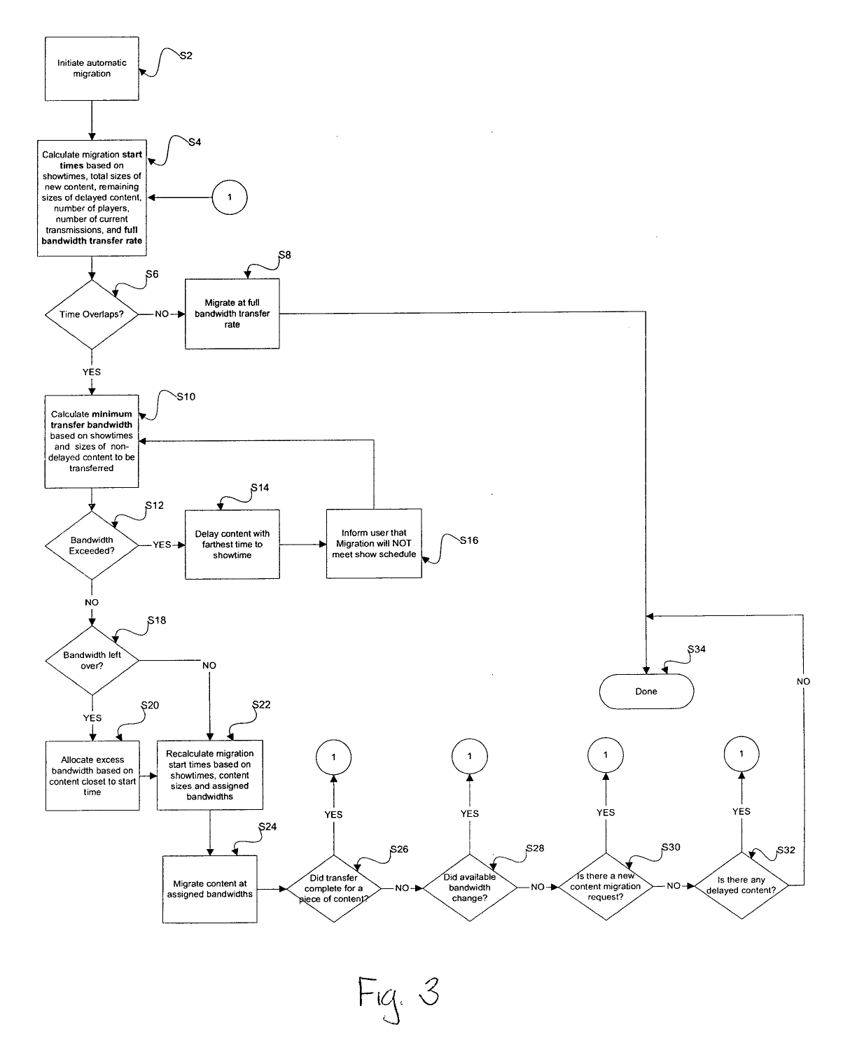

Referring briefly to FIG. 3, there is shown the flowchart of the migration process preferably implemented as software, firmware or the like. The migration engine 40 initiates automatic migration S2 and determines the prioritization and migration rate of the content. The migration engine 40 first calculates start times for migration S4 for the desired content. This means that the migration engine 40 determines (a) the start times for migration of each piece of digital content (currently migrating file(s), new file or any file(s) that have been delayed) based on the file size to be transferred and (b) the maximum available bandwidth from the content library 50 to the player 60 for each piece of content. Checks are then made to determine if there are time overlaps S6 (i.e., a second migration is to begin before the first migration is to be completed). If no time overlaps are detected in the migrations, then each migration proceeds at full speed S8 at the calculated start time. If time overlaps are detected, the migration engine recalculates S10 the migration rates as described hereinbelow.

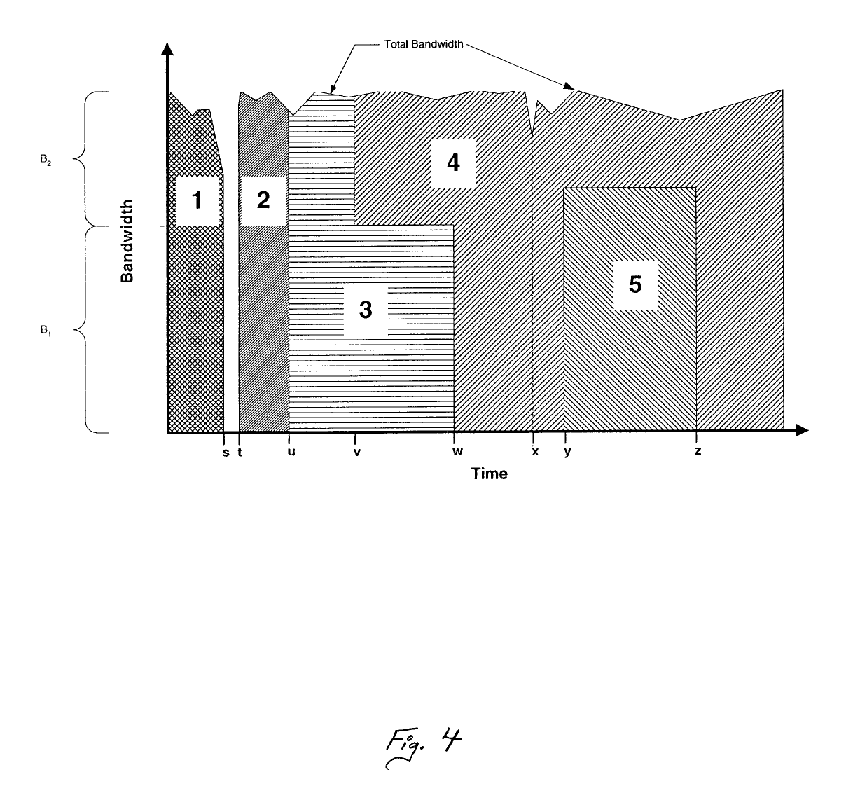

Referring to FIG. 4, there is shown a graphical illustration of no time overlaps and time overlaps. One example of no time overlaps occurs when migration of movie 1 ends (at time s) before the start of migration of movie 2 (at time t). Time u illustrates still another example of no time overlap between movie 2 and movie 3. Referring to time v, an example of a time overlap is when migration of movie 3 is still occurring and migration of movie 4 begins. It is noted that at time v in FIG. 4, movie 3 is currently migrating (i.e., current transmission). Another example of current transmission is at time y of movie 4.

Referring back to FIG. 3, in S10, the migration engine 40 recalculates, but this time, instead of calculating start times, it calculates the minimum transfer rates. This means that the migration engine 40 determines the minimum transfer rate required for each piece of digital content in order to be completely transferred to a player before showtime. A check is made to determine if the bandwidth is exceeded S12. If this calculation indicates that the maximum available bandwidth is exceeded, then obviously migration of at least one piece of content must be delayed S14, which is preferably the content with farthest time to showtime. The user is then informed of the delay S16. All of the non-delayed content is reevaluated at S10. This process (S10, S12, S14 and S16) is repeated until the bandwidth is not exceeded. It is noted that delayed content is reevaluated when migration start times are evaluated at S4. If the maximum available bandwidth is not exceeded on the initial check, then all content will be migrated in time to meet the required showtime, i.e., no content is delayed. If the maximum available bandwidth is not exceeded on a second or succeeding check, all non-delayed content will migrate to meet the required showtime.

If all of the available bandwidth is not used, then obviously there is some bandwidth left over S18. The remaining bandwidth is allocated as described herein below.

The migration engine 40 calculates the allocation of the excess bandwidth S20 to a particular piece of non-delayed content based on the showtime of the content. For example in FIG. 4, at time v, movie 3 is allocated more bandwidth at bandwidth B₁ than movie 4 (bandwidth B₂). Content with more immediate showtimes are allocated more of the excess bandwidth than content with showtimes farther in the future.

Migration start times are then recalculated based on content size, showtimes and the assigned bandwidth S22. Migration then proceeds at S24.

The migration engine 40 is further programmed to recalculate prioritizations and reallocation of bandwidth starting at S4: (1) whenever migration completes for a piece of content S26 (time w in FIG. 4); (2) total bandwidth changes S28 (time x in FIG. 4); (3) when new migration requests are made S30 (time v in FIG. 4); or (4) content has been delayed S32.

If no migration is needed after steps S32 or S8, the migration engine terminates further processing S34 until automatic migration is again initiated.

The migration engine 40 is further programmed to dynamically and continuously monitor total transmission bandwidth. For example, as shown in FIG. 4, the total bandwidth changes at point x due to inherent network characteristics, and this change is monitored so that bandwidth allocation can be adjusted.

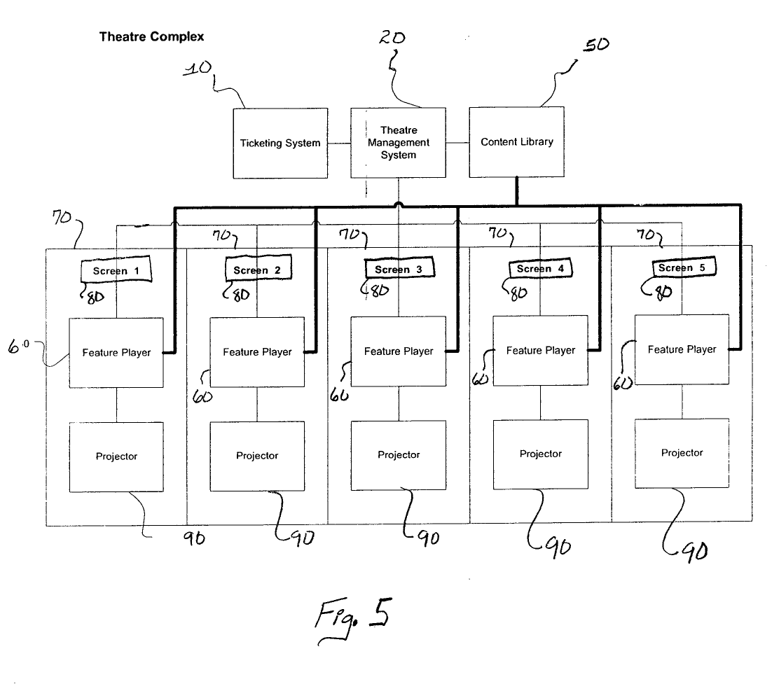

Referring to FIG. 5, there is shown a diagram illustrating the connections of theater management system 20 and content library 50 to each digital player 60. In this regard, each digital player 60 is preferably disposed in a distinct auditorium 70 each having a screen 80 onto which the movie is projected. Each auditorium 70 preferably includes a projector 90 connected to the digital player 60 for projecting the movie onto the screen. The digital player 60, also commonly referred to as a feature player, executes the schedule for the feature content and pre-show content that is then projected onto the screen by the projector.

The invention has been described with reference to a preferred embodiment. However, it will be appreciated that variations and modifications can be effected by a person of ordinary skill in the art without departing from the scope of the invention. For example, although five auditoriums are shown, any number of auditoriums could be used including only a single auditorium.

### PARTS LIST

10 ticketing system
15 movie theaters
20 theater management system
21 microprocessor-based unit
22 monitor
23 keyboard
24 mouse
25 touch-sensitive screen
30 schedule manager
40 migration engine
50 content library
60 digital content player
70 auditorium
80 screen
90 projector

1. A method for transmitting digital content, the method comprising the steps of:
(a) receiving a schedule of the digital content;
(b) determining transmission prioritization requirements for transmission of the digital content according to one or more of either: content size, schedule showtime, or network characteristics; and
(c) transmitting the digital content to one or more digital content players based on the determined prioritization.

2. The method as in claim 1 further comprising the step of determining the number of current transmissions for the movie theater.

3. The method as in claim 2 further comprising the step of determining current available transmission bandwidth for a network of digital content players.

4. The method as in claim 3 further comprising the step of determining size of the digital content that will be sent to the digital content players.

5. The method as in claim 1 further comprising the step of continuously and dynamically monitoring a total available transmission bandwidth.

6. The method as in claim 1 further comprising the step of delaying transmission of one or more digital content.

7. The method as in claim 1 further comprising the step of dynamically modifying an allocated transmission bandwidth for the digital content.

8. The method as in claim 7, wherein the step of dynamically modifying the allocated transmission bandwidth includes pausing the transmission of the digital content to a specific digital content player.

9. The method as in claim 1 further comprising the step of determining network characteristics includes learning from current and prior concurrent transmissions an actual total bandwidth.

10. The method as in claim 1, wherein step (b) includes calculating a transmission start time for the digital content.

11. The method as in claim 1, wherein step (b) also includes determining if time overlaps of the digital content transmission exist.

12. The method as in claim 1, where step (b) includes calculating minimum transfer bandwidth for the digital content transmission.

13. The method as in claim 1, wherein step (b) includes allocating excess bandwidth to the digital content transmission.

14. A theater management system comprising:
(a) a scheduler that schedules digital content; and
(b) an engine that receives the schedule and that prioritizes transmission of the digital content based on one or more of either content size, schedule showtime, or network characteristics.

15. The theater management system as in claim 14 further comprising a content player that sends or is directed to send the digital content to the digital content player.

16. A computer program product for transmitting digital content, comprising:
a computer readable storage medium having a computer program stored thereon for performing the steps of:
(a) receiving a schedule of the digital content;
(b) determining prioritization requirements for transmission of the digital content according to one or more of either content size, schedule showtime, and network characteristics; and
(c) directing transmittal of the digital content to one or more digital content players based on the determined prioritization.

17. The computer program product as in claim 16 further comprising the step of determining the number of current transmissions for the movie theater.

18. The computer program product as in claim 17 further comprising the step of determining current available transmission bandwidth for a network of digital content players.

19. The computer program product as in claim 18 further comprising the step of determining size of the digital content that will be sent to the digital content players.

20. The computer program product as in claim 16 further comprising the step of continuously and dynamically monitoring a total available transmission bandwidth either before or during transmission.

21. The computer program product as in claim 16 further comprising the step of delaying transmission of digital content.

22. The computer program product as in claim 16 further comprising the step of dynamically modifying an allocated transmission bandwidth for the digital content.

23. The computer program product as in claim 22, wherein the step of dynamically modifying the allocated transmission bandwidth includes pausing the transmission of the digital content to a specific digital content player.

24. The computer program product as in claim 16 further comprising the step of determining network characteristics includes learning from current and prior concurrent transmissions an actual total bandwidth.

25. The computer program product as in claim 1, wherein step (b) includes calculating a transmission start time for the digital content.
